(19) United States
(12) Patent Application Publication
(10) Pub. No.: US 2026/0125130 A1
(43) Pub. Date: May 7, 2026

(54) BICYCLE SADDLE

(71) Applicant: John Stephan Herold, Sauk Rapids, MN (US)

(72) Inventor: John Stephan Herold, Sauk Rapids, MN (US)

(21) Appl. No.: 19/293,467

(22) Filed: Aug. 7, 2025

Related U.S. Application Data
(60) Provisional application No. 63/715,490, filed on Nov. 1, 2024.

(51) Int. Cl. B62J 1/10

(52) U.S. Cl. CPC B62J 1/10

(57) ABSTRACT

A bicycle saddle includes a frame and a seat. The frame includes two front seat mount openings, and a rear guide rail. The rear guide rail includes a pair of guide rail openings. The seat includes two separate seat halves, each seat half having a front frame mounting opening and a rear locking strip. The rear locking strip has a plurality of openings.

### BACKGROUND

The use of bicycles has exploded with the popularity of e-bikes. The growth rate of e-bike sales from 2019 to 2022 was 269% with projections to grow another 300% from 2023 - 2029 with 2029 estimated sales of $7.5 billion dollars in North America.

There are significant differences between e-bikes and traditional bikes besides the powered drive train. Over 33% of e-bike consumers are casual riders aged 50-59 years old. The average weight of an e-bike is 60 pounds compared to less than 20 pounds for a traditional bike. The increased weight and lower center of gravity of the e-bike along with the elevated age of the typical user leads to more seat time while riding the bike. Most e-bikes provide a range of 50-100 miles. The casual older age group typically does not have a pelvic area “in shape” for long rides. For many e-bike riders the amount of ride time and distance is based on how much pelvic pain they can endure.

Further, a number of casual or new riders also use bicycles, but often do not continue such use due to the same issues of uncomfortable riding positions and pelvic pain.

### SUMMARY

In one aspect, a bicycle saddle includes a frame and a seat. The frame includes two front seat mount openings, and a rear guide rail. The rear guide rail includes a pair of guide rail openings. The seat includes two separate seat halves, each seat half having a front frame mounting opening and a rear locking strip. The rear locking strip has a plurality of openings.

Other aspects of the disclosure include each seat half comprising a slot in which its rear locking strip is seated, each rear locking strip accepting a releasable connector to secure the seat half to the frame rear guide rail. Further aspects include the rear guide rail being arced to allow lateral pivotal motion of each respective seat half about its respective front seat mounting opening. Each seat half slot may be a slot that accepts its rear locking strip in a position in which the guide rail openings are alignable with the plurality of openings of its rear locking strip. Each slot is arced to align with the arc of the rear guide rail.

Additional aspects include the rear guide rail having a set of graduated markings thereon for each seat half, each seat half being independently adjustable along the guide rail by adjusting a position of its respective releasable connector into one of the plurality of openings in its locking strip. The set of graduated markings increases from a center line of the rear guide rail outward to an outer edge of the guide rail in each lateral direction.

Each seat half front may be rotatably coupled to the frame via its front frame mounting opening. The rear guide rail may be arced to allow lateral pivotal motion of each respective seat half about its respective front seat mounting opening. Each seat half may comprise a slot in which its rear locking strip is seated, each rear locking strip accepting a releasable connector to secure the seat half to the frame rear guide rail. Each seat half slot accepts its rear locking strip in a position in which the guide rail openings are alignable with the plurality of openings of its rear locking strip, and each slot arced to align with the arc of the rear guide rail.

This summary is not intended to describe each disclosed embodiment or every implementation of the bicycle saddle and methods as described herein. Many other novel advantages, features, and relationships will become apparent as this description proceeds. The figures and the description that follow more particularly exemplify illustrative embodiments.

### BRIEF DESCRIPTION OF DRAWINGS

FIG. 1 is a perspective view of a bicycle saddle according to an embodiment of the present disclosure;

FIG. 2 is a side perspective view of a seat half of a bicycle saddle according to an embodiment of the present disclosure;

FIG. 3 is a top elevation view of the frame of the bicycle saddle of FIG. 1;

FIG. 4 is a sectional view of the guide rail of the bicycle saddle of FIG. 1;

FIG. 5 is a partial rear elevation view of a bicycle saddle frame according to an embodiment of the present disclosure;

FIG. 6 is a top view of the bicycle saddle of FIG. 1 in a first low width position according to an embodiment of the present disclosure;

FIG. 7 is a top view of the bicycle saddle of FIG. 1 in a second wide width position according to an embodiment of the present disclosure;

FIG. 8 is a partial rear elevation view of a bicycle saddle frame according to another embodiment of the present disclosure;

FIG. 9 is a partial rear elevation view of a bicycle saddle frame according to yet another embodiment of the present disclosure; and

FIG. 10 is a partial section view of the configuration indicated in FIG. 8.

### DETAILED DESCRIPTION

Embodiments of the present disclosure disclose a bicycle saddle comprised of two seat halves and a frame that allows a user to quickly and easily, without tools, independently adjust the seat width to accommodate different positions for the pelvic area of a rider, specifically in one embodiment the ischial tuberosity (i.e., sits bones or sitz bones). Adjustment of positions of the seat halves may ay be symmetrical or asymmetrical.

Embodiments of the present disclosure prove a convenient, tool-free option for an optimum initial seating position and easily change the width during a ride to several new positions providing new pressure points in the pelvic area alleviating pain and prolonging ride time.

Each seat half of a bicycle saddle of embodiments of the present disclosure is adjustable symmetrically or asymmetrically to a desired width using quick release mechanisms without any tools. The ability for a rider to easily adjust seat width without tools allows the user to find the optimal initial seat width and the ability to adjust the seat width during rides to provide new pressure points and alleviate pelvic pain providing a longer and more comfortable ride. A user may set the seat width to a desired initial width to start a ride, and quickly and easily change the seat width during a short break to change the pressure points for the pelvic area, alleviating discomfort and increasing ride time and comfort. Seat width may easily be changed multiple times to multiple positions during each ride.

The disclosure is directed in one embodiment to traditional pedal powered bicycles. However, it should be understood that other bicycles, tricycles, unicycles, tandems, e-bikes, stationary bicycle, trainer, exercise equipment that uses a saddle, or the like may have a rider who wishes to adjust a seat width, and therefore, such other conveyances are amenable to use with embodiments of the present disclosure, and are within the scope thereof.

The seat halves can be adjusted symmetrically or asymmetrically. Though most users will prefer to adjust the seats symmetrically, asymmetrical adjustment may be desired for riders with health conditions or impairments such as replaced hips or foot/leg abnormalities.

It should be noted that the same reference numerals are used in different figures for same or similar elements. It should also be understood that the terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

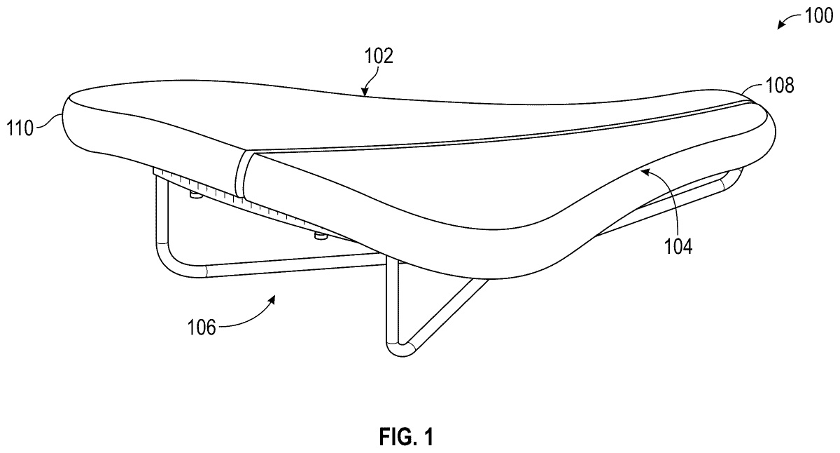

FIG. 1 is a perspective view of a bicycle saddle 100 according to an embodiment of the present disclosure. Bicycle saddle 100 comprises first seat half 102 and second seat half 104 mounted to a frame 106. The first seat half and the second seat half are adjustable laterally, pivoting about a connection between each respective seat half 102, 104, and the frame 106, at or adjacent a front 108 of the saddle 100. In one embodiment, the front 108 has a fastening mechanism between the seat halves and the frame. Adjacent to or at the rear 110 of the saddle 100, a fastening mechanism is positioned to connect the frame 106 and the individual seat halves 102, 104.

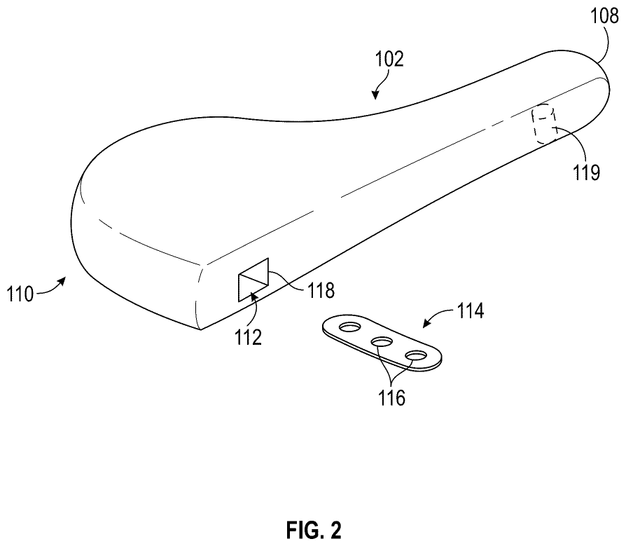

FIG. 2 is a side perspective view of seat half 102. At the rear 110 of the saddle 100, seat half 102 has a slot 112 that extends in an arc within the seat half 102. In cross-section, in one embodiment, the slot 112 is rectangular, and in one embodiment substantially square in cross section. A locking strip 114 is positioned and secured within the slot 112 in one embodiment. The locking strip 114 has a plurality of openings 116 therethrough. When secured within the slot 112, the locking strip 114 is located in the upper part 118 of the slot 112, with the openings 116 laterally across the seat half 102 in the slot 112. A front frame mounting opening 119 is positioned at or adjacent the front 108, for attachment to the frame 106, as described further below. FIG. 2 illustrates a left half 102. Right half 104 is a mirror image of half 102, with corresponding parts.

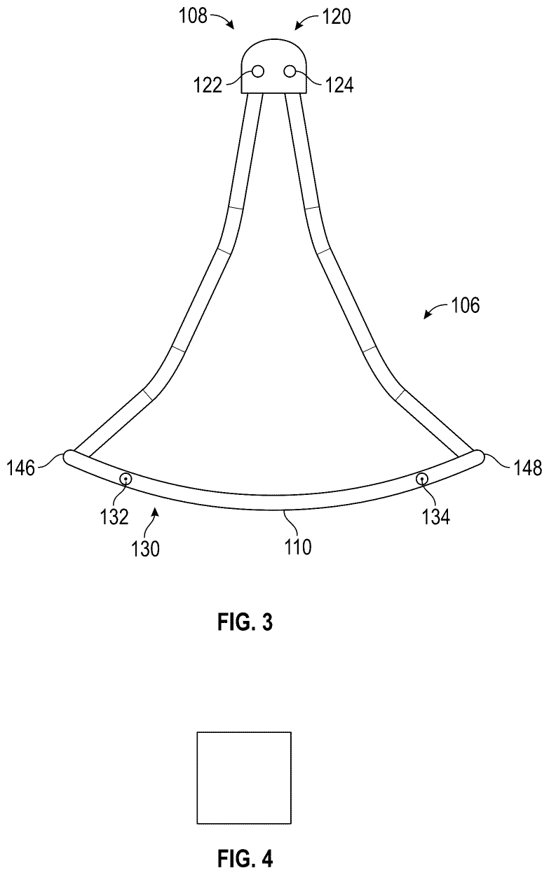

FIG. 3 is a top elevation view of a frame 106 according to an embodiment of the present disclosure. The front 108 of the seat frame 106 has a frame mounting plate 120. The mounting plate 120 has in one embodiment a pair of front seat mount openings 122 and 124. Opening 122 is configured to allow fastening of a seat half 102, and opening 124 is configured to allow fastening of a seat half 104, to the frame 106. In one embodiment, the attachment is by placing a fastener (not shown) such as a bolt, or the like, through the opening 122, 124 and into the front frame mounting opening 119 through its respective front seat mount opening. In this way, each seat half 102, 104 is laterally pivotable about the fastener.

The rear 110 of the seat frame 106 has in one embodiment a continuous arced guide rail 130. A pair of guide rail openings 132 and 134, are provided in the guide rail 130 for releasable attachment to the respective seat halves 102 and 104 via their slots 112, locking strips 114, and openings 116. The guide rail 130 in one embodiment has a cross section as shown in FIG. 4. The shape of the guide rail 130 is configured to mate with the slot 112 of a seat half 102, 104, so that the rear 110 of the seat half 102, 104 is rotatable through the arc of its respective portion of the guide rail 130 about the fastener of its seat half 102, 104 to the frame 106 at its front frame mount opening 119.

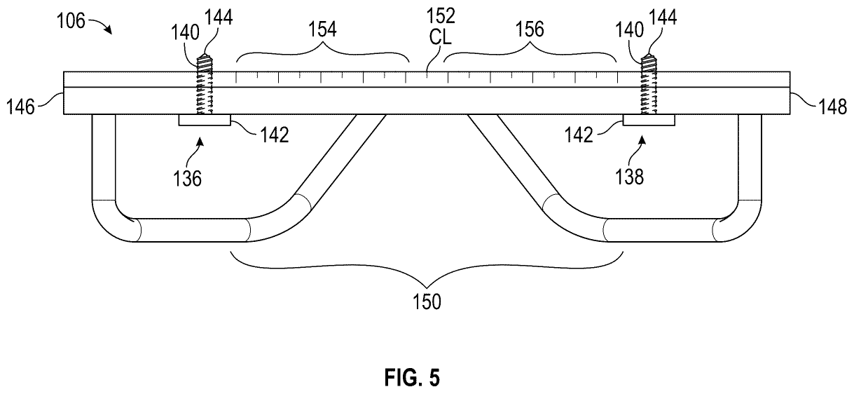

Referring now also to FIG. 5, the guide rail 130 openings 132, 134 house in one embodiment a releasable device 136, 138, such as a quick release lever, a spring plunger, or the like, to engage an opening of the plurality of openings 116 of the locking strip 114 of slot 112 of its respective seat half 102, 104. The quick release device 136, 138 releasably fixes the seat frame 106 to its respective seat half 102, 104 at the desired seat half position by extending a catch or other portion of the quick release device 136, 138 into one of the plurality of openings 116 in its respective locking strip 114. The plurality of openings 116 in the locking strip 114 correspond to a number of laterally pivoted positions of the seat half 102, 104, from a closest to the center position to a farther from the center position of the seat half 102, 104. That is, each seat half 102, 104 is adjustable in position to make a rear of the seat wider or narrower depending on the opening 116 of the locking strip 114 into which the quick release device 136, 138 is secured.

In one embodiment, each quick release device 136, 138 comprises a spring loaded plunger 140 with a knob 142 on one end and a taper 144 on the other end. An internal spring biases the tapered end 144 of the plunger away from the knob end 142 of the plunger to place the taper 144 into an opening 116 in locking strip 114. In another embodiment, a release device comprises a cam lever in the frame 106 and a plurality of serrations or other gradation in the seat half 102, 104. It should be understood that any type of quick release device that disengages the frame and the seat half at the rear thereof is amenable for use with embodiments of the present disclosure, and is within the scope thereof. The quick release device 136, 138 is operable by a user without using tools for the release or adjustment.

In one embodiment, a rear of the guide rail 130 is marked with gradation marks 150. The gradation marks 150 include in one embodiment a lateral center line 152. The center line 152 is at a center of the frame 106 from a left side 146 of the frame 106 to a right side 148 of the frame 106. A first set of graduated markings 154 extends from the center line 152 of the guide rail 130 toward the left side 146. A second set of graduated markings 156 extends from the center line 152 of the guide rail 130 toward the right side 148. The graduated markings 154, 156 indicate a distance from the center line 152 that the respective seat half 102, 104 has moved off the center line 152. As the seat half is moved to a position of a larger graduated mark (e.g., farther from the center line 152 toward the left side 146 or right side 148) the overall seat width increases. As the seat half is moved to a position of a smaller graduated mark (e.g., closer to the center line 152 from the left side 146 or right side 148), the overall seat width decreases. In one embodiment, the graduated markings 154, 156 are identically spaced on either side of the center line 152.

In one embodiment, each graduated marking aligns with an opening of the plurality of openings 116 in the locking strip 114. However, it should be understood that the number of openings and number of graduated markings may be different, or larger or smaller than what is shown or discussed, without departing from the scope of the disclosure.

The adjustment of the seat half positions may easily be made symmetrical from side to side by moving the seat halves 102, 104 to the same graduated marking away from the center line. The adjustment of the seat half positions may also be asymmetrical by moving the seat halves 102. 104 to different graduated markings. This may be helpful for non-traditional riders, such as those with some physical disabilities, one leg shorter than the other, replaced hips, or the like, to allow for a comfortable seat position. The release devices (e.g., devices 136, 138 or other release devices) are operable without tools to adjust seat half positions.

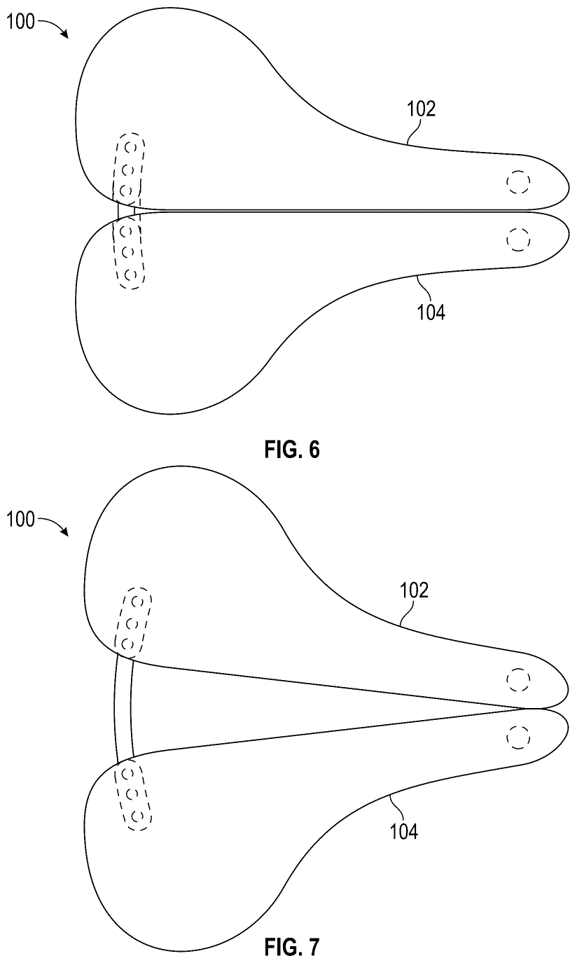

FIG. 6 shows an embodiment of the bicycle saddle 100 in a first position that is its narrowest. FIG. 7 shows the embodiment of FIG. 6 in a second position that is its widest. It should be understood that a different first and second width, wider or narrower, is within the scope of the disclosure.

Seat and frame materials may be chosen in order to provide value, durability, weight support, or the like. Such decisions are known to one of skill in the art, and therefore not discussed further herein.

Operation and assembly of a bicycle saddle as shown in the embodiments of the disclosure is as follows.

With a releasable device 136, 138 that uses a spring plunger, for example, to adjust a seat half 102, 104, pulling the knob 142 on the quick release device 136, 138 compresses the internal spring and retracts the plunger 140 and therefore the tapered end 144. The respective seat half 102, 104 may then be rotated to align one of the openings 116 in its locking strip 114 with the release device 136, 138 at a desired position indicated by the graduated markings 154, 156 on the guide rail 130.

Advantages of the present disclosure include but are not limited to easy adjustment of seat halves in symmetric or asymmetric configurations without using tools, and graduated markings to assist in the easy alignment.

The adjustment is made tool-free by the use of quick release mechanism to adjust seats using, for example only and not by way of limitation, spring plungers. Cam levers and serrations or other quick release mechanisms may be used without departing from the scope of the disclosure.

Fixed rotation points for the seat halves at the nose of the seat allow for simple adjustments of seat half positions. The guide rail 130 is configured to have different arcs to accommodate each pivot point. Alternatively, the front seat mount openings 122, 124 may be configured as slots instead of round openings to provide lateral movement of the front of the seat halves 102, 104 to use with a single arc guide rail 130.

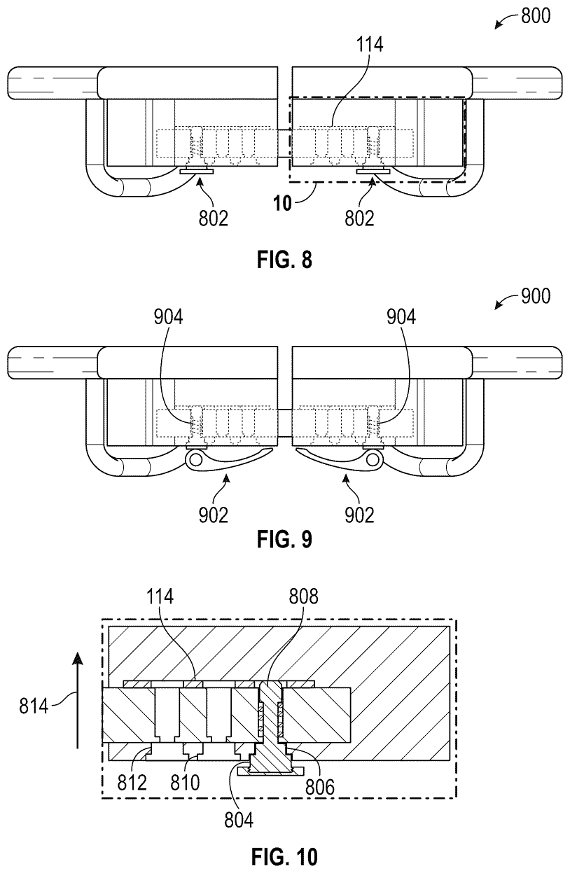

A spring plunger embodiment 800 for the bicycle saddle is shown in greater detail in FIG. 8. A plunger 802 is operable in this embodiment to have a head 804 that is of a diameter to engage an opening 810 in the seat, with a smaller diameter portion 806 that engages an integrated locking strip 812 in the seat, and a smaller diameter shaft with head 808 that extends through the rail and into an opening 116 of upper locking strip 114. The plunger is spring biased in an upward direction as indicated by arrow 814.

Referring now to FIG. 9, a quick release lever 902 may also be operable in another embodiment 900 to rotate a pin 904 through the guide rail and into an opening 116 in the locking strip 114 to secure the seat halves in position.

FIG. 10 is a cross-section of the area 10 of FIG. 8, showing the engagement of the plunger 802 with a seat half in greater detail.

The above-disclosed subject matter is to be considered illustrative, and not restrictive, and the appended claims are intended to cover all such modifications, enhancements, and other embodiments, which fall within the true scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A bicycle saddle, comprising:
a frame, comprising:
two front seat mount openings; and
a rear guide rail, the rear guide rail including a pair of guide rail openings; and
a seat, comprising two separate seat halves, each seat half comprising a front frame mounting opening and a rear locking strip, the rear locking strip having a plurality of openings.

2. The bicycle saddle of claim 1, wherein each seat half comprises a slot in which its rear locking strip is seated.

3. The bicycle saddle of claim 2, wherein each rear locking strip accepts a releasable connector to secure the seat half to the frame rear guide rail.

4. The bicycle saddle of claim 3, wherein the rear guide rail is arced to allow lateral pivotal motion of each respective seat half about its respective front seat mounting opening.

5. The bicycle saddle of claim 4, wherein each seat half slot accepts its rear locking strip in a position in which the guide rail openings are alignable with the plurality of openings of its rear locking strip.

6. The bicycle saddle of claim 5, wherein each slot is arced to align with the arc of the rear guide rail.

7. The bicycle saddle of claim 3, wherein the rear guide rail has a set of graduated markings thereon for each seat half, each seat half adjustable along the guide rail by adjusting a position of its respective releasable connector into one of the plurality of openings in its locking strip.

8. The bicycle saddle of claim 7, wherein the set of graduated markings increases from a center line of the rear guide rail outward to an outer edge of the guide rail in each lateral direction.

9. The bicycle saddle of claim 3, wherein the releasable connector is a quick release connector.

10. The releasable connector of claim 9, wherein the quick release connector is a quick release lever.

11. The releasable connector of claim 9, wherein the quick release connector is a plunger engaging one of the plurality of openings in the locking strip.

12. The bicycle saddle of claim 3, wherein the releasable connector is releasable without using tools.

13. The bicycle saddle of claim 1, wherein each seat half front is rotatably coupled to the frame via its front frame mounting opening.

14. The bicycle saddle of claim 13, wherein the rear guide rail is arced to allow lateral pivotal motion of each respective seat half about its respective front seat mounting opening.

15. The bicycle saddle of claim 14, wherein:
each seat half comprises a slot in which its rear locking strip is seated;
each rear locking strip accepts a releasable connector to secure the seat half to the frame rear guide rail;
each seat half slot accepts its rear locking strip in a position in which the guide rail openings are alignable with the plurality of openings of its rear locking strip; and
each slot is arced to align with the arc of the rear guide rail.

16. The bicycle saddle of claim 1, wherein each seat half is independently adjustable.

17. A bicycle saddle, comprising
a frame, comprising:
two front seat mount openings; and
a rear guide rail, the rear guide rail including a pair of guide rail openings; and
a seat, comprising two separate seat halves, each seat half comprising a front frame mounting opening and a rear locking strip, the rear locking strip having a plurality of openings, each seat half independently adjustable using a quick release connector to secure and release the sear half to and from the frame.
